(19) United States
(12) Patent Application Publication
(10) Pub. No.: US 2011/0111643 A1
(43) Pub. Date: May 12, 2011

(54) Audio Connector

(76) Inventors: Te-Hung Yin, Taipei (TW); Shu-Fang Li, Taipei (TW); Jui-Pin Lin, Taipei (TW); Yung-Yi Chen, Taipei (TW)

(21) Appl. No.: 12/614,395

(22) Filed: Nov. 7, 2009

(51) Int. Cl. H01R 24/04

(52) U.S. Cl. 439/668

(57) ABSTRACT

An audio connector has an insulating housing having a body. The body has a passageway for receiving an audio plug, and a plurality of installing holes of column shape, each of which extends along a direction substantially perpendicular to an extending direction of the passageway, with one end thereof intercommunicating with the passageway, and the other end thereof reaching an outer surface of the body. A plurality of probe assemblies is respectively mounted to the installing holes. Each of the probe assemblies has a hollow barrel, a plunger slidably mounted to the barrel and exposing from one end of the barrel for projecting into the passageway resiliently, and an elastic element received in the barrel for supporting the plunger. The other end of the barrel is extended opposite to the plunger to form a soldering portion exposing outside the insulating housing.

### BACKGROUND OF THE INVENTION

1. Field of the Invention

The present invention relates to an audio connector, and particularly to an audio connector having a better performance for holding a mating plug for a long-term use.

2. The Related Art

FIG. 5 is a cross-sectional view of an audio connector 10 in prior art. The audio plug 10 has an insulating housing 11 and a plurality of contacts 12 mounted to the insulating housing 11. The insulating housing 11 has a passageway 13 for receiving a mating plug (not shown). The contacts 12 are disposed around the passageway 13. A free end of each contact 12 is arched to form an arc contact end 121, projecting into the passageway 13 for electrically connecting with the inserted plug. Meanwhile, the contact ends 121 clamp the inserted plug for guaranteeing the stable and firm connection between the audio connector 10 and the plug. However, since the plug frequently inserts into and withdraws from the audio plug 10 so that the contact ends 121 are pressed to deform and released repeatedly, the resilience of the contact ends 121 decreases gradually. As a result, the audio connector 10 is likely not to hold the plug firmly, which may result in the failure of electrical connection therebetween and affect normal use.

### SUMMARY OF THE INVENTION

Accordingly, an object of the present invention is to provide an audio connector is capable of improving the connection stability with a mating audio plug. The audio connector has an insulating housing having a body. The body has a passageway for receiving the audio plug, and a plurality of installing holes of column shape. Each of the installing holes extends along a direction substantially perpendicular to an extending direction of the passageway, with one end thereof intercommunicating with the passageway, and the other end thereof reaching an outer surface of the body. A plurality of probe assemblies is respectively mounted to the installing holes. Each of the probe assemblies has a hollow barrel, a plunger slidably mounted to the barrel and exposing from one end of the barrel, and an elastic element received in the barrel for supporting the plunger. The other end of the barrel is extended opposite to the plunger to form a soldering portion exposing outside the insulating housing. The plungers project into the passageway resiliently for holding and contacting the inserted audio plug.

As described above, the audio connector has the probe assemblies, serving as contacts, replacing the conventional contacts which are formed by punching and bending a metal strip. In use, the plungers are pressed by the audio plug to elastically compress the corresponding elastic elements. On the contrary, the elastic forces stored in the compressed elastic elements support the plungers for holding the audio plug. Since the resilience of the elastic element is strong and permanent, the probe assemblies will be better to hold the inserted audio plug and capable of guaranteeing the stable connection between the audio connector and the audio plug in the long-term use.

### BRIEF DESCRIPTION OF THE DRAWINGS

The present invention will be apparent to those skilled in the art by reading the following description thereof, with reference to the attached drawings, in which:

FIG. 1 is a cross-sectional view of an audio connector of an embodiment in accordance with the present invention;

FIG. 2 is an exploded, cross-sectional view of the audio connector shown in FIG. 1;

FIG. 3 is a cross-sectional view of a probe assembly of the audio connector shown in FIG. 2;

FIG. 4 is a cross-sectional view showing the assembling state of the audio connector of FIG. 1 and a mating plug; and

FIG. 5 is a cross-sectional view of an audio connector in prior art.

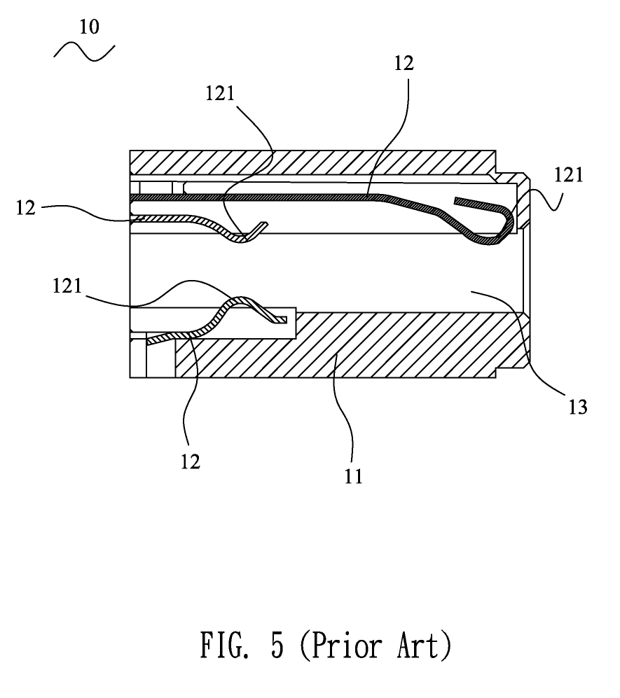

### DETAILED DESCRIPTION OF THE EMBODIMENT

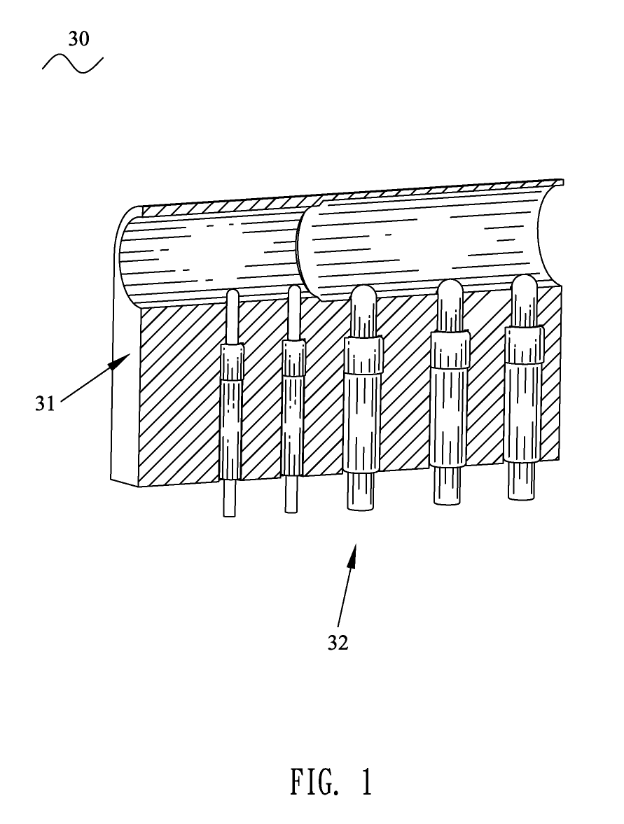

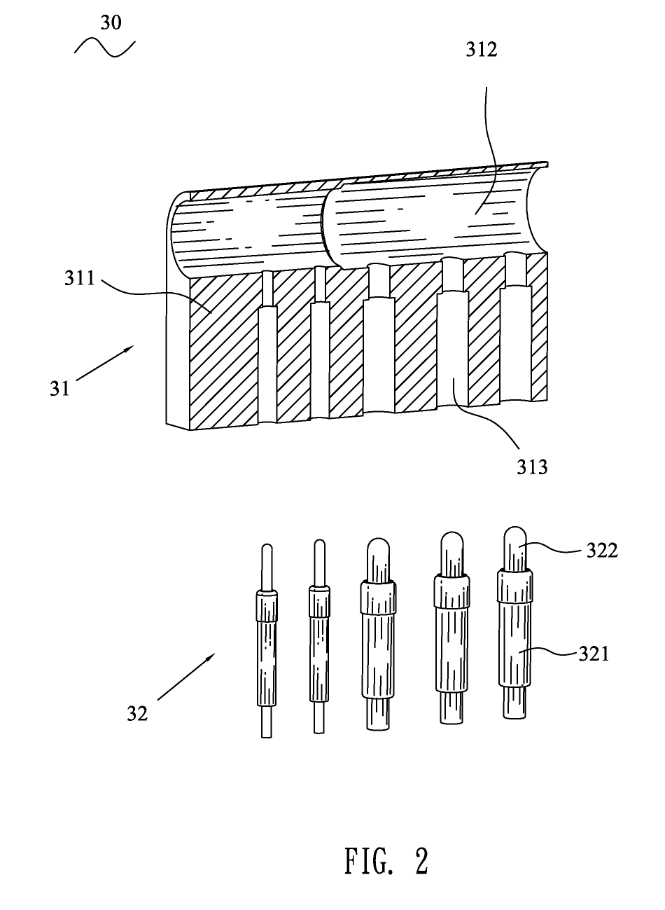

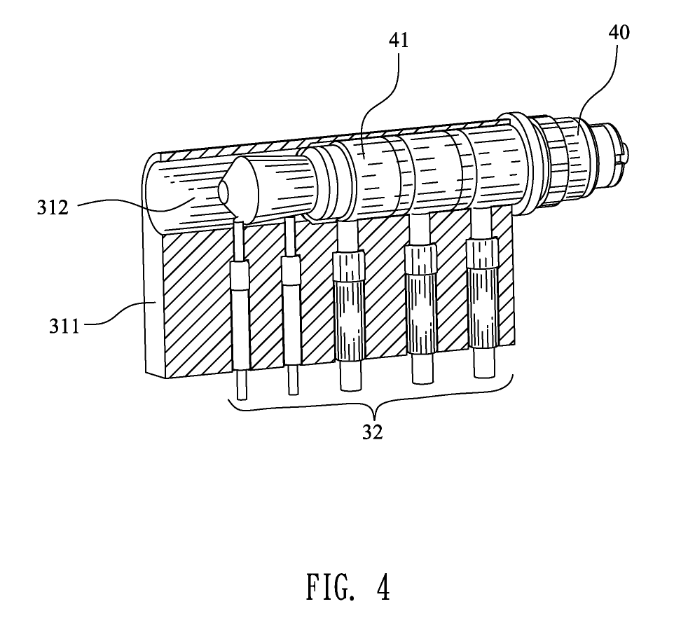

Referring to the drawings in greater detail, and first to FIGS. 1-2, the embodiment of the invention is embodied in an audio connector 30. The audio connector 30 comprises an insulating housing 31, and a plurality of probe assemblies 32 mounted to the insulating housing 31. The insulating housing 31 has a body 311. The body 311 has a passageway 312 at an upper portion thereof, for receiving a mating plug 40 (shown in FIG. 4). The passageway 312, with a circular cross-section, extends along a lengthwise direction of the body 311 which is parallel to an insertion direction of the plug 40. A plurality of installing holes 313 of column shape is formed at a lower portion of the body 311, for receiving the probe assemblies 32. The installing holes 313 extend perpendicularly to an extending direction of the passageway 312 and reach a bottom side of the passageway 312. Herein, the installing holes 313 are aligned with one another.

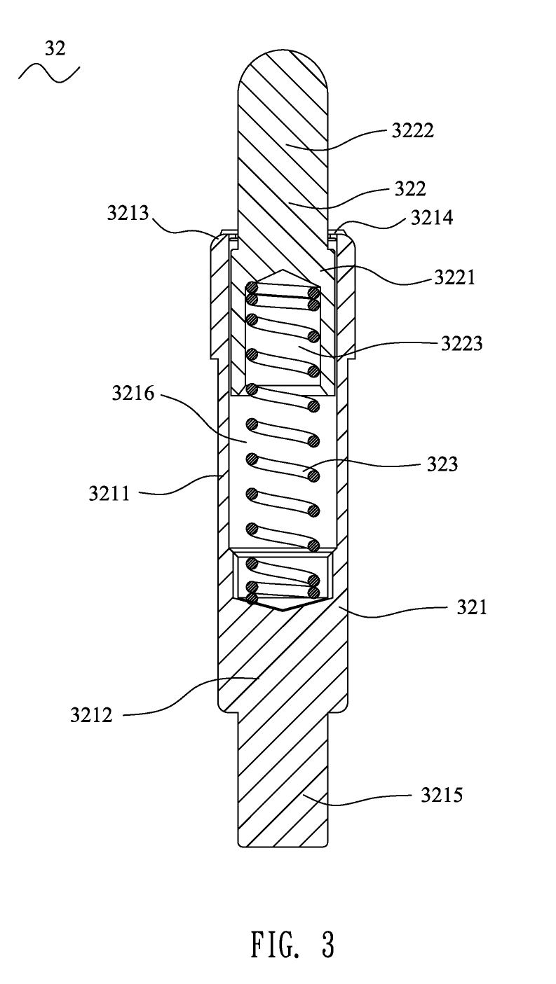

With reference to FIG. 3, each of the probe assemblies 32 has a hollow barrel 321, a plunger 322 and an elastic element 323 received in the barrel 321. The barrel 321 and the plunger 322 are made of metallic material. The barrel 321 defines a cylindraceous main body 3211, surrounding a chamber 3216, a closed end 3212 for blocking one end of the elastic element 323, and an open end 3213 opposite to the closed end 3212. An outer surface of the closed end 3212 has a portion extending opposite to the main body 3211 to form a soldering portion 3215. The soldering portion 3215 has an outer dimension less than that of the main body 3211. Herein, the soldering portion may be of column shape or plate shape.

The plunger 322 of cylindrical shape includes a basic portion 3221 and a contact portion 3222 extending outwards from one end of the basic portion 3221. The basic portion 3221 is restrained in the chamber 3216 of the barrel 321, where the other end of the basic portion 3221 has a positioning hole 3223 for receiving the other end of the elastic element 323. In addition, the other end of the basic portion, also, could be formed with an inclining surface for deflecting the plunger in use, or protruded opposite to the contact portion to form a positioning rod which is inserted into the other end of the elastic element. The contact portion 3222 extends out of the barrel 321 through the open end 3213 of the barrel 321. When the plunger 322 is mounted to the barrel 321, the open end 3213 is bent inwards to form a blocking shoulder 3214 blocking the basic portion 3221 for preventing the plunger 322 from departing from the barrel 321. The elastic element 323 is disposed in the chamber 3216 of the barrel 321, for supporting the plunger 322. Herein, the elastic element 323 is a spring.

Please refer to FIGS. 2-4, in assembly, the probe pin assemblies 32 are inserted into the corresponding installing holes 313. The contact portions 3222 are partly inserted into the passageway 312. The soldering portions 3215 project outside a bottom of the insulating housing 31 for being soldered on a PCB (not shown). The plug 40 has an audio terminal 41 of column shape. The audio terminal 41 is inserted into the passageway 312 and presses the contact portions 3222. Correspondingly, the spring 323 under the plunger 322 is compressed and provides an elastic force which acts on the plunger 322 to rest against the inserted audio terminal 41. Thus the inserted audio terminal 41 is held firmly and connects with the contact portions 3222 stably.

It should be noted that the outer peripheral dimension of the probe assemblies can be changed for meeting different demands and should not be limited. In this embodiment, there are five probe assemblies, two of which are thinner than others. In addition, the installing positions of the probe assemblies can also be changed and not be limited as mentioned above, for being convenient to manufacture and assemble.

As described above, the audio connector 30 has the probe assemblies 32, serving as contacts, replacing the conventional contacts which are formed by punching and bending a metal strip. In use, the plungers 322 are pressed by the audio terminal 41 of the plug 40 to elastically compress the corresponding springs 323. On the contrary, the elastic forces stored in the compressed springs 323 support the plungers 322 for holding the audio terminal 41. Since the resilience of the spring 323 is strong and permanent, the probe assemblies 32, as the contacts, are better to hold the inserted audio terminal 41 and capable of guaranteeing the stable connection between the audio connector 30 and the plug 40 in the long-term use.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An audio connector adapted for receiving a mating audio plug, comprising:
an insulating housing having a body, the body having a passageway for receiving the audio plug, and a plurality of installing holes of column shape, each of the installing holes extending along a direction substantially perpendicular to an extending direction of the passageway, with one end thereof intercommunicating with the passageway, and the other end thereof reaching an outer surface of the body; and
a plurality of probe assemblies, each of the probe assemblies having a hollow barrel, a plunger slidably mounted to the barrel and exposing from one end of the barrel, and an elastic element received in the barrel for supporting the plunger, the other end of the barrel extended opposite to the plunger to form a soldering portion,
wherein the plural probe assemblies are respectively mounted to the installing holes, the soldering portions expose outside the insulating housing, the plungers project into the passageway resiliently for holding and electrically contacting the inserted audio plug.

2. The audio connector as claimed in claim 1, wherein the passageway is formed at an upper portion of the body.

3. The audio connector as claimed in claim 2, wherein the installing holes are formed at a lower portion of the body and reach a bottom side of the passageway.

4. The audio connector as claimed in claim 3, wherein the installing holes are substantially aligned with one another.

5. The audio connector as claimed in claim 1, wherein the soldering portion has an outer dimension less than that of the barrel.
